(19) United States
(12) Patent Application Publication
(10) Pub. No.: US 2021/0232102 A1
(43) Pub. Date: Jul. 29, 2021

(54) Safety system and method for localizing a person or object in a monitored zone using a safety system

(71) Applicant: SICK AG, Waldkirch (DE)

(72) Inventors: Markus HAMMES, Waldkirch (DE); Mathias AMS, Waldkirch (DE)

(21) Appl. No.: 17/159,883

(22) Filed: Jan. 27, 2021

(30) Foreign Application Priority Data
Jan. 28, 2020 (EP) 20154108.3

(51) Int. Cl. G05B 9/02; G01S 17/04; G01S 17/08; G01S 17/86

(52) U.S. Cl. CPC G05B 9/02; G01S 17/86; G01S 17/08; G01S 17/04

(57) ABSTRACT

A method of localizing a person or object in a monitored zone using a safety system, having a movable machine, having a control and evaluation unit, having at least one radio location system, and having at least one spatially resolving sensor for the position determination of the person or object, wherein the radio location system has arranged radio stations, wherein at least one radio transponder is arranged at the person or object, wherein position data of the person or object can be determined by means of the radio location system, and wherein the position data are transmitted from the radio stations of the radio location system to the control and evaluation unit and position data of the person or object are determined by means of the spatially resolving sensor, wherein the control and evaluation unit compares the position data of the radio location system and the position data of the spatially resolving sensor and forms tested position data on an agreement.

The present invention relates to a safety system for localizing a person or object and to a method of localizing a person or an object in a monitored zone using a safety system.

Sensor systems of functional safety have currently reached a level that basic physical features of the environment, for example geometrical information such as distances, lengths, or the presence of objects per se can be reliably detected and can be used in simple safety functions. In contrast, higher value information or derived meanings, for example the information on what type of object it is, are as a rule not reliably detectable by sensors and are therefore also not usable from a safety engineering aspect.

In this sense, in particular the information whether it is an object or a person or not is of interest for higher value safety functions. An object classification is generally already a very complex process since as rule image data are used for this purpose that then have to be processed in a very laborious manner. This as a rule produces expensive sensors frequently having substantial latency times.

Optoelectronic safety sensors, for example laser scanners or light grids, very reliably detect the presence of an object or person. Such safety sensors are in widespread use in the safeguarding of hazard areas of machines and enable the implementation of very simple safety functions.

Machine movements are as a rule stopped or slowed on a detection of an object relevant to safety. What type of object it is or where exactly the object is located in the configured protected zone is left out of consideration in this process. This information is generally also not available at all or is not usable for safety engineering purposes.

A simple detection function of safety sensors that are present permits a reliable safeguarding of hazard areas, but as a rule has negative effects on a productivity of a machine. Independently of a class of the detected object, for example of a person, an article, or a disturbance or disturbing articles and independently of the exact position of the object, it is necessary to switch off for safety relevant reasons even if this response would not be necessary in certain cases.

In particular safe knowledge that a detected object is a person or not would enable a very much more specific monitoring of a potentially hazardous machine.

In accordance with DE 10 2012 102 236 A1, a sensor unit for safeguarding a hazardous working zone of a machine working in an automated manner delivers a respective current 3D image of the working zone at defined time intervals. An evaluation unit comprises a failsafe extraneous object detector, a classifier, a person tracker, and a comparator. The extraneous object detector generates a first signal in dependence on the respective current 3D image and in dependence on a defined protected zone, said first signal having first position information that is representative for the position of an extraneous object in the protected zone. The classifier attempts to identify the extraneous object as a person. The person tracker tracks the identified person via a series of respective current 3D images and determines a second piece of position information that represents the current position of the identified person after every new 3D image. If the position of the extraneous object in accordance with the first position information and the position of the identified person differ from one another, a control signal is generated to stop the machine.

DE 1 0 2017 123 295 A1 discloses a safety system for safeguarding a cooperative operation of humans, robots, and machines at a technical system. The safety system comprises a first safety relevant device that is configured to monitor a first hazardous zone of the technical system and to switch the technical system into a hazard free state when a hazard situation has been recognized. The safety system is furthermore configured to identify an autonomously operating technical unit and to register the autonomously operating technical unit when it satisfies a defined condition and to restrict the monitoring of the first hazardous zone by the first safety relevant device as a response to the registration.

An object of the invention comprises enabling a safe distinction of a permitted person or a permitted object and an unauthorized person or unauthorized object. High quality safety functions such as the direct interaction between a person and an actuator or between an object and an actuator can thus be implemented.

The object is satisfied by a safety system for localizing a person or an object in a monitored zone having at least one movable machine, having a control and evaluation unit, having at least one radio location system, and having at least one spatially resolving sensor for the position determination of the person or object, wherein the radio location system has arranged radio stations, wherein at least one radio transponder is arranged at the person or object, wherein position data of the person or object can be determined by means of the radio location system, and wherein the position data can be transmitted from the radio stations of the radio location system to the control and evaluation unit and position data of the person or object can be determined by means of the spatially resolving sensor, and the control and evaluation unit is configured to compare the position data of the radio location system and the position data of the sensor and to form tested position data on an agreement.

The object is further satisfied by a method of localizing a person or object in a monitored zone using a safety system having at least one movable machine, having a control and evaluation unit, having at least one radio location system, and having at least one spatially resolving sensor for the position determination of the person or object, wherein the radio location system has arranged radio stations, wherein at least one radio transponder is arranged at the person or object, wherein position data of the person or object are determined by means of the radio location system, and wherein the position data are transmitted from the radio stations of the radio location system to the control and evaluation unit and position data of the person or object are determined by means of the spatially resolving sensor, and the control and evaluation unit compares the position data of the radio location system and the position data of the sensor system and forms tested position data on an agreement.

The safety system is at least formed by the control and evaluation unit, the radio location system, and the spatially resolving sensor.

The invention is based on the fact that a position of the person or the object can be unambiguously identified by two part systems independent of one another. On the one hand, the position is determined via the spatially resolving sensor and the position that is determined via the radio location system. The position is thus determined by a redundant, in particular diverse, system.

The invention uses the combination of two diverse sensor technologies that mutually validate one another with respect to the detection task.

The first of the two sensor technologies is the radio location system or a radio based localization system by which the positions of radio transponders can be determined exactly to within a few centimeters.

The radio location is, here, for example, based on a triangulation of at least one radio transponder at the person or object. At least three radio stations that can detect the radio transponder are required for this purpose. The distance between the respective radio stations is known to the radio location system here.

It is preferably a real time location system (RTLS). The radio transponder or radio transponders is/are here arranged at the person or object. The radio stations receive the radio signals from the radio transponders and can thus determine their position and so the position the person or object.

In this respect, position data are transmitted from the radio location system, namely the radio stations, to the control and evaluation unit.

The second system is the spatially resolving sensor or a spatially resolving environment detection system. No radio transponder is required for the localization here. This environment detection system or the spatially resolving sensor therefore delivers information that an object is located at a specific position and determines its position and dimensions or contour.

The two diverse part systems, namely the radio location system and the spatially resolving sensor, complement one another very well with respect to the functional tasks of position detection and can therefore be mutually combined for validation and so for a safety engineering positioning.

A validation of an object position or person position could therefore schematically run as follows:

The radio location system determines the position of an object or person. This information is transmitted to the control and evaluation unit.

The control and evaluation unit optionally transmits a search field in which the radio location system has located the person or object to the spatially resolving sensor.

The spatially resolving sensor checks whether a person or an object is present in its detection zone or search field, optionally with its size and optionally other detected validation parameters such as shape, speed, etc. The spatially resolving sensor transmits the detected data to the control and evaluation unit.

The detected position of the person or of the object of the radio location system and the detected position of the person or object of the spatially resolving sensor are compared with one another by the control and evaluation unit.

The control and evaluation unit optionally compares the detected features or the contour of the person or object of the spatially resolving sensor with the detected features or contour of the person or object of the radio location system.

The person position or object position can thus be mutually validated by the two diverse information channels and can thus be checked for a safety engineering application.

The invention enables a safe position recognition of persons or objects in a monitored zone and thus opens up the option of tailoring a safety function specifically to a respective situation. There is thus the possibility of satisfying a demand for risk reduction without impairing a productivity of an automation process.

The physical principles of action and their strengths and weaknesses of the diverse sensors are advantageously complementary. Radio location systems, for example, have a natural immunity to extraneous light due to the principle of action. Radio location systems are furthermore less sensitive to interfering objects such as dust, chips, or mist. In addition, it becomes possible by radio location systems to see through non-metallic walls so that a particularly early recognition of persons or objects is possible. This permits a high quality optimization of processes with a constant ensuring of occupational safety.

The object can be stationary or mobile articles. The object is, for example, transport material or processing material.

The movable machine or mobile machine can, for example, be a robot having movable robot arms. The movable machine thus has a drive and can be moved in different directions.

In other words, the invention comprises complementing a classical safety function using presence detection by means of the spatially resolving sensor and a safety directed shutdown by a safe position determination. The classical safety function by the spatially resolving sensor here serves as a fallback function that steps in if the safe positioning fails.

In a further development of the invention, the control and evaluation unit is configured to compare the position data of the radio location system and the position data of the sensor and, on agreement, to permit the person or the object having the radio transponder in a protected field of the spatially resolving sensor and not to output any object determination signal, whereby the movable machine is in an active state.

If the position of an object or person was able to be detected with the required safety engineering reliability in the protected field, the classical safety function is bridged (muting) and a machine control can optionally make use of the position data of the object or person for the situation based safeguarding of the machine.

in accordance with the further development, the spatially resolving sensor that is used in a stationary manner to safeguard the machine or the actuator, additionally provides its measured data to enable a positioning of the person or of the object in the protected field. In this way, on the presence of the position data of the radio location system and the position data of the spatially resolving sensor, a validation of the position of the person or of the object is made possible and thus accessible to a safety engineering use of the position information.

In addition to this redundant and diverse sensor structure, the error case must also be checked for the safety engineering usability that the position data of the radio location system are lacking or the position data of the spatially resolving sensor do not agree with the position data of the radio location system.

In accordance with the present invention, a validation dependent bridging or muting of the safety function of the primary safety function, that is the protected field monitoring, is therefore provided by the spatially resolving sensor, according to which on an agreement of the position data of the spatially resolving sensor and of the radio location system, the person or object having the radio transponder is to be permitted in a protected field of the spatially resolving sensor and no object detection signal is to be output, whereby the actuator is in an active state.

It is decisive in this process that the primary safety function remains muted for so long as the validation of the position data of the radio location system and the position data of the spatially resolving sensor is successful.

The validation of the two independent position data or pieces of position information is carried out by the control and evaluation unit. The control and evaluation unit is optionally a functionally safe control and evaluation unit. The control and evaluation unit has means for error localization, for example. These means are, for example, means for testing, for example a redundant and/or diverse structure having two channels for a mutual check of the determined results and the position data.

In a further development of the invention, the spatially resolving sensor and the radio stations are arranged as stationary. It is thus a stationary application, wherein the movable machine is, for example, a robot, a handling machine, or the like. The movable machine can also be a processing machine, for example a press or a punching machine, that can likewise be in direct interaction with a person or object.

In a further development of the invention, the spatially resolving sensor and the radio stations are arranged as mobile at a movable machine. It is thus a mobile application, wherein the movable machine is, for example, a vehicle, in particular a driverless vehicle, or the like. The vehicle can likewise be in direct interaction with a person or object.

In a further development of the invention, checked position data are formed on the basis of the position data of the radio location system and the position data of the sensor, with the control and evaluation unit being configured to compare the checked position data with reference data and on an agreement a change of the safety function of the safety system taking place by means of the control and evaluation unit, with the actuator being operated in a non-dangerous operating mode.

In accordance with the further development of the invention, a safe collaboration between the movable machine or the actuator and the person can be implemented. Depending on the position, speed, direction of movement, and/or the distance of the person, the movable machine or the actuator is braked, stopped, diverted, and/or accelerated again.

The movable machine is in particular operated in a non-dangerous operating mode when the person or object is located in a dangerous zone of the movable machine.

Safety critical error cases such as the loss of the radio signal, e.g. because no radio transponder is present, because an energy supply of the radio transponder has failed, or because, for example, the radio transponder is screened, or an erroneous localization of the person or object by the spatially resolving sensor, or the defective processing of position data by the control and evaluation unit, result in a safety directed shutting down by the primary safety function, namely by the control and evaluation unit, if no valid position data from the spatially resolving sensor are present.

In a further development of the invention, the control and evaluation unit is configured to set a changed safety function on the basis of the checked position data of the control and evaluation unit, with a movement of the movable machine being changed or influenced by the control and evaluation unit in dependence on the distance of the person from the movable machine.

For example, a changed safety function is set by means of the control and evaluation unit, with the control and evaluation unit converting the checked position information into a safe distance from the hazard site and influencing a movement of the movable machine in dependence on the distance from the person.

In accordance with the further development of the invention, a safe collaboration between the movable machine or the actuator and the person can likewise be implemented. Depending on the position, speed, direction of movement, and/or the distance of the person, the movable machine or the actuator is braked, stopped, diverted, and/or accelerated again.

In a further development of the invention, the radio location system is an ultrawide band radio location system, with the frequency used being in the range from 3.1 GHz to 10.6 GHz, with the transmission energy per radio station amounting to a maximum of 0.5 mW.

An absolute bandwidth in an ultrawide band radio location system amounts to at least 500 MHz or a relative bandwidth amounts to at least 20% of the central frequency.

The range of such a radio location system amounts, for example, to 0 to 50 m. In this respect, the short time duration of the radio pulses is used for the localization. The radio location system thus only transmits radio waves having a low energy. The system can be used very flexibly and has no interference.

At a minimum only one single radio transponder has to be arranged at the person or object, said radio transponder being detected by at least three radio stations arranged as stationary, with the spacing of the radio stations being known.

A plurality of radio stations, for example more than three, are preferably arranged that monitor at least some of the movement zone of the person or object.

At least two or more radio transponders can also be arranged at the person or object. The position of the person or object can thereby be identified more exactly and the alignment of the person or object in the stationary state can also be detected when the arrangement of the radio transponders at the person or object is known.

In a further development of the invention, the spatially resolving sensor is an optoelectronic sensor, an ultrasound sensor, or a radar sensor.

With a time of flight sensor, the light that is transmitted by a light transmitter and that is remitted by the person or object is received by a light receiver and the time of flight from the transmission from the person or object is evaluated, whereby the distance from the person or object can be determined.

The sensor can, however, also be an ultrasound sensor or a radar sensor.

An ultrasound sensor transmits ultrasound and evaluates the reflected sound waves, that is the echo signals. Frequencies from 16 kHz onward are used here. Detection ranges from a few centimeters to a number of meters can be implemented here.

A radar sensor is a sensor that transmits a so-called primary signal as a bundled electromagnetic wave that receives echoes reflected from persons or objects as a secondary signal and evaluates it according to different criteria. This is a localization, namely the determination of distance and angle.

Position information or the position can be acquired from the received waves reflected from the person or object. As already mentioned, the angle or the direction of the object and the distance from the person or object can be determined from the time shift between the transmission and reception of the signal. The relative movement between the transmitter and the person or object can furthermore also be determined, for example by a simple multiple measurement at time intervals. The arrangement of individual measurements after one another delivers the distance and the absolute speed of the object. Contours of the person or object can be recognized with a corresponding resolution of the radar sensor.

An irradiation from the radar sensor takes place, for example, largely bundled in one direction due to the antenna design. The radiation characteristics of the antenna then has a so-called lobe shape.

The wavelength of the radar is in the range of the radio waves in the short wave to microwave range. A pulse radar sensor transmits pulses having a typical duration in the lower microsecond range and then waits for echoes. The transit time of the pulse is the time between the transmission and the reception of the echoes. It is used for distance determination.

A direction of the scanning beam of a pulse radar sensor can also be effected, instead of by the alignment of the antenna or antennas, electronically by phase-controlled antenna arrays. A plurality of objects can be targeted and almost simultaneously tracked in a fast alternating manner by this.

The radar sensor works at a power of approximately 10 mW, for example. This power is so low that there are no health effects. The radar frequency licensed for this application is, for example, in the range from 76-77 GHz, corresponding to a wavelength of approximately 4 mm.

In a further development of the invention, the spatially resolving sensor is configured for the at least areal monitoring of a monitored zone.

The spatially resolving sensor for the at least areal monitoring of a monitored zone is a sensor for distance measurement. The distance sensor delivers distance values in at least two-dimensional space. In so doing, the sensor outputs measured values with distance indications and angle indications. For example, the distance is determined by means of time of flight methods or triangulation methods.

In a further development of the invention, the spatially resolving sensor is configured for the at least spatial monitoring of a monitored zone.

In a further development of the invention, the optoelectronic sensor is a laser scanner, a safety laser scanner, a 3D camera, a stereo camera, or a time of flight camera.

The spatially resolving scanner, the laser scanner, the safety laser scanner, the 3D camera, the stereo camera, or the time of flight camera monitors a two-dimensional or three-dimensional monitored zone or a measured data contour for the position detection. It can synonymously be a monitored field.

Safety systems used in safety engineering have to work particularly reliably and intrinsically safely and must therefore satisfy high safety demands, for example the standard EN13849 for safety of machinery and the machinery standard EN1496 for electrosensitive protective equipment (ESPE).

To satisfy these safety standards, a series of measures have to be taken such as a secure electronic evaluation by redundant and/or diverse electronics or different functional monitoring processes, especially the monitoring of the contamination of optical components, including a front lens. A safety laser scanner in accordance with such standards is known, for example, from DE 43 40 756 A1.

The term “functionally safe” is to be understood in the sense of the standards named or of comparable standards; measures are therefore taken to manage errors up to a specified safety level. The safety system can therefore be configured as intrinsically safe. The safety system and/or at least one safe sensor moreover generate unsafe data such as raw data, point clouds, or the like. Unsafe is the opposite of safe for unsafe devices, transmission paths, evaluations, and the like and accordingly said demands on failsafeness are not satisfied.

A 3D camera, for example, likewise monitors a monitored zone by means of a plurality of detected distance values. A 3D camera has the advantage that a volume-like protected zone can be monitored.

A stereo camera, for example, likewise monitors a monitored zone of means of a plurality of detected distance values. The distance values are determined on the basis of the two camera of the stereo camera that are installed at a base spacing from one another. A stereo camera equally has the advantage that a volume-like protected zone can be monitored.

Distance values determined by an image sensor are determined by means of a time of flight camera on the basis of the measured time of. A time of flight camera equally has the advantage that a volume-like or spatial protected zone can be monitored.

The invention will also be explained in the following with respect to further advantages and features with reference to the enclosed drawing and to embodiments. The Figures of the drawing show in:

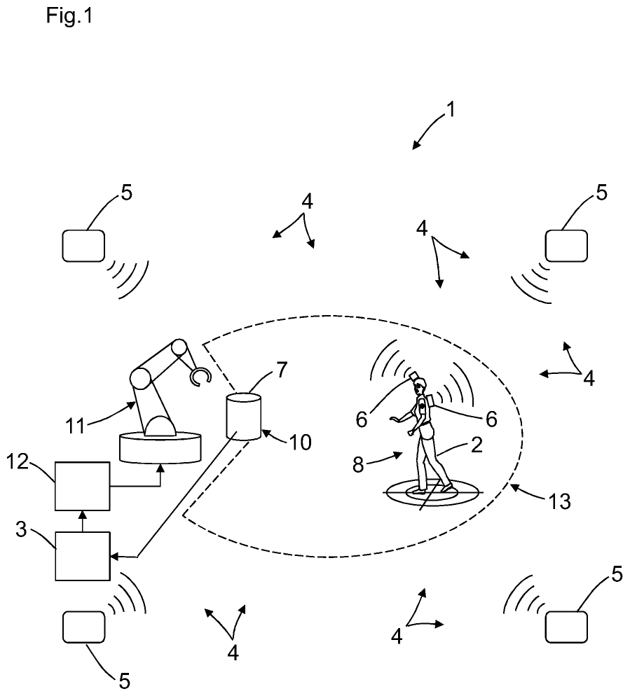

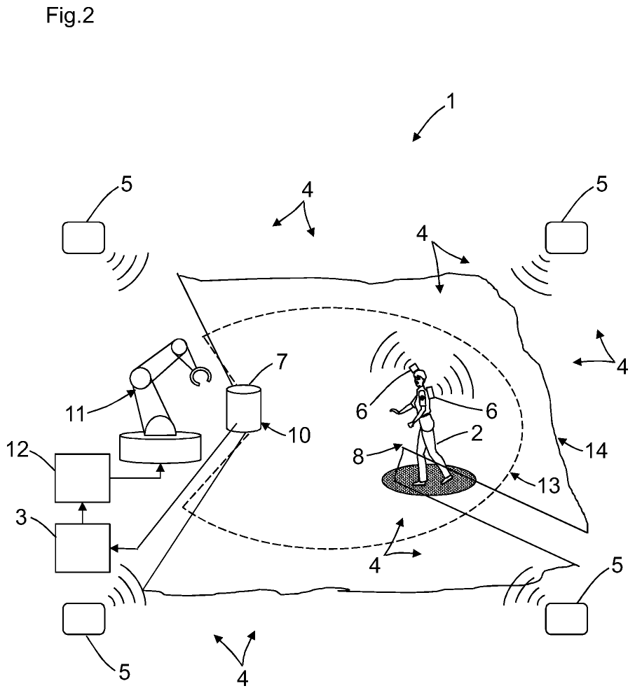

FIGS. 1 and 2 respectively, a safety system in a schematic representation;

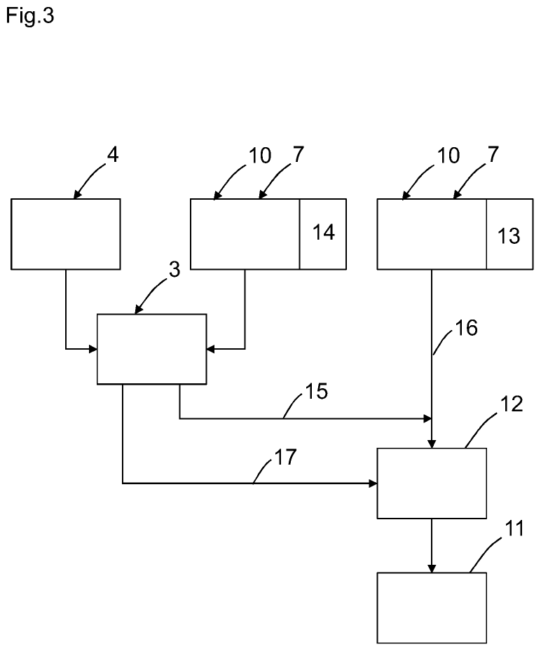

FIG. 3 a safety system in a block diagram

In the following Figures, identical parts are provided with identical reference numerals.

FIG. 1 shows a safety system 1 for localizing a person 2 or object 8 in a monitored zone having a movable machine 11, having a control and evaluation unit 3, having at least one radio location system 4, and having at least one spatially resolving sensor 7 for the position determination of the person 2 or object 8, wherein the radio location system 4 has arranged radio stations 5, wherein at least one radio transponder 6 is arranged at the person 2 or object 8, wherein position data of the person 2 or object 8 can be determined by means of the radio location system 4, and wherein the position data can be transmitted from the radio stations 5 of the radio location system 4 to the control and evaluation unit 3 and position data of the person 2 or object 8 can be determined by means of the spatially resolving sensor 7, and the control and evaluation unit 3 is configured to compare the position data of the radio location system 4 and the position data of the spatially resolving sensor 7 and to form checked position data on an agreement.

Optionally, in accordance with FIG. 2, the control and evaluation unit 3 is configured to compare the position data of the radio location system 4 and the position data of the spatially resolving sensor 7 and, on agreement, to permit the person 2 or the object 8 having the radio transponder 6 in a protected field 13 of the spatially resolving sensor 7 and not to output any object determination signal, whereby the movable machine 11 is in an active state.

FIG. 3 shows a block structure with the different signals. In accordance with FIG. 3, a classical safety function having a presence detection by the spatially resolving sensor 7 and a safety directed shutdown 16 is complemented by a safe position determination. The laser scanner 10 in accordance with FIG. 3 and FIG. 2 monitors a two-dimensional monitored zone or a measured data contour 14 for the position detection. It can synonymously be a monitored field. The classical safety function by the spatially resolving sensor 7 here serves as a fallback function that steps in if the safe positioning fails. If, however, the position of an object or person was able to be detected with the required safety engineering reliability in the protected field 13, the classical safety function is muted by means of a muting signal 15 and a machine control 12 can optionally make use of safe or checked position data 17 of the object 8 or person 2 for the situation based safeguarding of the movable machine 11.

In accordance with FIG. 1, the spatially resolving sensor 7 that is used in a stationary manner to safeguard the movable machine 11 or the actuator, additionally provides measured data to enable a positioning of the person 2 or object 8 in the protected field 13. In this way, on the presence of the position data of the radio location system 4 and the position data of the spatially resolving sensor, 7 a validation of the position of the person 2 or object 8 is made possible and thus accessible to a safety engineering use of the position information.

In addition to this redundant and diverse sensor structure, the error case must also be checked for the safety engineering usability that the position data of the radio location system 4 or the position data of the spatially resolving sensor 7 do not agree with the position data of the radio location system 4.

In accordance with FIG. 1, a validation dependent bridging or muting of the safety function of the primary safety function, that is the protected field monitoring by the spatially resolving sensor 7 is therefore provided, according to which on an agreement of the position data of the spatially resolving sensor 7 and of the radio location system 4, the person 2 or object 8 having the radio transponder is to be permitted in a protected field of the spatially resolving sensor and no object detection signal is to be output, whereby the movable machine 11 or the actuator is in an active state.

It is decisive in this process that the primary safety function remains muted for so long as the validation of the position data of the radio location system 4 and the position data of the spatially resolving sensor 7 is successful.

The validation of the two independent position data or pieces of position information is carried out by the control and evaluation unit 3. The control and evaluation unit 3 is optionally a functionally safe control and evaluation unit 3. The control and evaluation unit 3 has means for error localization, for example. These means are, for example, means for testing, for example a redundant and/or diverse structure having two channels for a mutual check of the determined results and the position data.

In accordance with FIG. 1, the spatially resolving sensor 7 and the radio stations 5 are arranged as stationary. It is thus a stationary application, wherein the movable machine 11 is, for example, a robot, a handling machine, or the like. The movable machine 11 can also be a processing machine, for example a press or a punching machine, that can likewise be in direct interaction with a person 2 or object 8.

In accordance with an embodiment, not shown, the spatially resolving sensor and the radio stations are arranged as mobile at a movable machine. It is thus a mobile application, wherein the movable machine is, for example, a vehicle, in particular a driverless vehicle, or the like. The vehicle can likewise be in direct interaction with a person or object.

In accordance with FIG. 1, checked position data are formed on the basis of the position data of the radio location system 4 and the position data of the spatially resolving sensor 7, with the control and evaluation unit 3 being configured to compare the checked position data with reference data and on an agreement a change of the safety function of the safety system 1 taking place by means of the control and evaluation unit, with the movable machine 11 or the actuator being operated in a non-dangerous operating mode.

In accordance with FIG. 1, a safe collaboration between the movable machine 11 or the actuator and the person 2 can be implemented. Depending on the position, speed, direction of movement, and/or the distance of the person 2, the movable machine 11 or the actuator is braked, stopped, diverted, and/or accelerated again.

The movable machine 11 is in particular operated in a non-dangerous operating mode when the person 2 or object 8 is located in a dangerous zone of the movable machine 11.

Safety critical error cases such as the loss of the radio signal, e.g. because no radio transponder 6 is present, because an energy supply of the radio transponder 6 has failed, or because, for example, the radio transponder 6 is screened, or an erroneous localization of the person 2 or object 8 by the spatially resolving sensor 7, or the defective processing of position data by the control and evaluation unit, 3 result in a safety directed shutting down by the primary safety function, namely by the control and evaluation unit 3, if no valid position data from the spatially resolving sensor 7 are present.

In accordance with FIG. 2, the radio location system 4 is optionally an ultrawide band radio location system, with the frequency used being in the range from 3.1 GHz to 10.6 GHz, with the transmission energy amounting to a maximum of 0.5 mW per radio station.

At a minimum only one single radio transponder 6 has to be arranged at the person 2 or object 8, said radio transponder 6 being detected by at least three radio stations 5 arranged as stationary, with the spacing of the radio stations 5 being known.

A plurality of radio stations 5, for example more than three, are preferably arranged that monitor at least some of the movement zone of the person 2 or object 8.

At least two or more radio transponders 6 can also be arranged at the person 2 or object 8. The position of the person 2 or object 8 can thereby be identified more exactly and the alignment of the person 2 or object 8 in the stationary state can also be detected when the arrangement of the radio transponders 6 at the person 2 or object 8 is known.

In accordance with FIG. 1, the spatially resolving sensor 7 is an optoelectronic sensor, an ultrasound sensor, or a radar sensor.

With a time of flight sensor as the optoelectronic sensor, the light that is transmitted by a light transmitter and that is remitted by the person 2 or object 8 is received by a light receiver and the time of flight from the transmission up to the reception by the person or object 8 is evaluated, whereby the distance from the person 2 or object 8 can be determined.

The spatially resolving sensor 7 can, however, also be an ultrasound sensor or a radar sensor.

In accordance with FIG. 1, the spatially resolving sensor 7 is configured for the at least areal monitoring of a monitored zone.

The spatially resolving sensor 7 for the at least areal monitoring of a monitored zone is a sensor for distance measurement. The distance sensor delivers distance values in at least two-dimensional space. In so doing, the spatially resolving sensor 7 outputs measured values with distance indications and angle indications. For example, the distance is determined by means of time of flight methods or triangulation methods.

In accordance with an embodiment that is not shown, the spatially resolving sensor is configured for the at least spatial monitoring of a monitored zone.

In accordance with FIG. 1, the optoelectronic sensor can be a laser scanner 10 or a safety laser scanner.

In accordance with an embodiment that is not shown, the spatially resolving sensor is a 3D camera, a stereo camera, or a time of flight camera.

### REFERENCE NUMERALS

1 safety system
2 person
3 control and evaluation unit
4 radio location system
5 radio stations
6 radio transponder
7 spatially resolving sensor
8 object
10 laser scanner
11 movable machine
12 machine control
13 protected field
14 measured contour
15 muting signal
16 safety directed shutdown
17 safe or checked position data

1. A safety system for localizing at least one person or at least one object in a monitored zone, the safety system comprising:
at least one movable machine,
a control and evaluation unit,
at least one radio location system, and
at least one spatially resolving sensor for the position determination of the person or object,
wherein the radio location system has arranged radio stations;
wherein at least one radio transponder is arranged at the person or object;
wherein position data of the person or of the object can be determined by means of the radio location system;
wherein the position data can be transmitted from the radio stations of the radio location system to the control and evaluation unit, and position data of the person or of the object can be determined by means of the spatially resolving sensor, and
wherein the control and evaluation unit is configured to compare the position data of the radio location system and the position data of the sensor and to form checked position data on an agreement.

2. The safety system in accordance with claim 1,
wherein the control and evaluation unit is configured to compare the position data of the radio location system and the position data of the sensor and, on agreement, to permit the person or the object having the radio transponder in a protected field of the spatially resolving sensor and not to output any object determination signal, whereby the movable machine is in an active state.

3. The safety system in accordance with claim 1, wherein the spatially resolving sensor and the radio stations are arranged as stationary or are arranged as mobile at a movable machine.

4. The safety system in accordance with claim 1, wherein checked position data are formed on the basis of the position data of the radio location system and the position data of the sensor, with the control and evaluation unit being configured to compare the checked position data with reference data and on an agreement a change of the safety function of the safety system taking place by means of the control and evaluation unit, with the actuator being operated in a non-dangerous operating mode.

5. The safety system in accordance with claim 1, wherein the control and evaluation unit is configured to set a changed safety function on the basis of the checked position data of the control and evaluation unit, with a movement of the movable machine being changed or influenced by the control and evaluation unit in dependence on the distance of the person from the movable machine.

6. The safety system in accordance with claim 1, wherein the radio location system is an ultrawide band radio location system, with the frequency used being in the range from 3.1 GHz to 10.6 GHz, with the transmission energy amounting to a maximum of 0.5 mW per radio station.

7. The safety system in accordance with claim 1, wherein the spatially resolving sensor is an optoelectronic sensor, an ultrasonic sensor, or a radio sensor.

8. The safety system in accordance with claim 1, wherein the spatially resolving sensor is configured for an at least areal monitoring of a monitored zone.

9. The safety system in accordance with claim 1, wherein the spatially resolving sensor is configured for an least spatial monitoring of a monitored zone.

10. The safety system in accordance with claim 1, wherein the optoelectronic sensor is one of a laser scanner, a safety laser scanner, a 3D camera, a stereo camera, and a time of flight camera.

11. A method of localizing a person or object in a monitored zone using a safety system, the safety system comprising at least one movable machine, a control and evaluation unit, at least one radio location system, and at least one spatially resolving sensor for the position determination of the person or object,
wherein the radio location system has arranged radio stations;
wherein at least one radio transponder is arranged at the person or object;
wherein position data of the person or of the object are determined by means of the radio location system;
wherein the position data are transmitted from the radio stations of the radio location system to the control and evaluation unit;
and position data of the of the person or of the object are determined by means of the spatially resolving sensor,
characterized in that the control and evaluation unit compares the position data of the radio location system and the position data of the sensor and forms checked position data on an agreement.
